(19) United States
(12) Patent Application Publication
(10) Pub. No.: US 2011/0007132 A1
(43) Pub. Date: Jan. 13, 2011

(54) Method and system for brightness correction for three-dimensional (3D) projection

(76) Inventors: William Gibbens Redmann, Glendale, CA (US); Mark J. Huber, Burbank, CA (US); Joshua Pines, San Francisco, CA (US)

Correspondence Address: Robert D. Shedd, Patent Operations;THOMSON Licensing LLC, P.O. Box 5312, Princeton, NJ, 08543-5312, US

(21) Appl. No.: 12/803,791

(22) Filed: Jul. 7, 2010

Related U.S. Application Data
(60) Provisional application No. 61/223,596, filed on Jul. 7, 2009.
(60) Provisional application No. 61/261,286, filed on Nov. 13, 2009.

(51) Int. Cl. H04N 13/00; G03B 21/14; G02B 27/22

(52) U.S. Cl. 348/42; 353/121; 353/7; 359/462; 348/E13.001

(57) ABSTRACT

A method and system are disclosed for brightness correction for use in three-dimensional (3D) projection of film-based or digital images. Based on brightness information for a projection system, brightness adjustment can be provided, which can be used for correcting brightness disparity in stereoscopic images for 3D projection.

### CROSS-REFERENCE TO RELATED APPLICATIONS

This application claims priority to U.S. Provisional Application Ser. No. 61/223,596, “Method and System for Luminance Correction for 3D Projection” filed on Jul. 7, 2009, and U.S. Provisional Application Ser. No. 61/261,286, “Method and System for Luminance Correction for Three-Dimensional (3D) Projection” filed on Nov. 13, 2009, both of which are herein incorporated by reference in their entirety.

### TECHNICAL FIELD

The present invention relates to a method and system for luminance correction for use in three-dimensional (3D) projection.

### BACKGROUND

The current wave of 3-dimensional (3D) movies is gaining popularity and made possible by the ease of use of 3D digital cinema projection systems. However, the rate of rollout of those systems is not adequate to keep up with demand, partly because of the relatively high cost involved. Although earlier 3D film-based systems suffered from various technical difficulties, including mis-configuration, low brightness, and discoloration of the picture, they were considerably less expensive than the digital cinema approach. In the 1980's, a wave of 3D films were shown in the US and elsewhere, making use of a lens and filter designed and patented by Chris Condon (U.S. Pat. No. 4,464,028). Other improvements to Condon were proposed, such as by Lipton in U.S. Pat. No. 5,481,321. Subject matter in both references are herein incorporated by reference in their entirety.

One lens configuration, the over-and-under lenses or “dual-lens” arrangement (e.g., an upper lens for projecting an image for one eye, and a lower lens for projecting an image for the other eye) project the corresponding left- and right-eye images with a differential brightness that is especially egregious at the top and bottom portions of the presentation screen. In this discussion, the term “differential brightness” may be used to denote the existence of a disparity or difference between the brightness of the images of a stereoscopic pair (a stereoscopic image pair refers to the left- and right-eye images for a specific frame or scene), and depending on the context, it may also refer to a measure or indicator of the differences in brightness. In those contexts where a measure is used, differential brightness is the ratio of the brightness of one image with respect to the brightness of the other, usually (but not necessarily) with the brightness of the brighter image being the numerator. This brightness disparity arises because the illumination in a motion picture projector is typically brighter in the middle of the opening in the aperture plate, near the optical axis of the illuminator and associated condenser optics. The luminous flux (i.e., amount of light passing through regions of the film) falls off smoothly away from this bright center of the opening in the aperture plate.

In a stereoscopic projector with a dual-lens configuration, the left- and right-eye images from a film or digital file are provided above and below this bright center, with the luminous flux being highest near the bottom of one image and the top of the other image. The different brightness contours for the illumination of the left- and right-eye images can lead to detrimental effects such as difficulty in perceiving the desired 3D effect, perception of scintillation in certain region of the image, or causing eye-strain for the audience.

Since this dual-lens configuration is used in many film-based and some digital projection systems, the presence of brightness disparity can adversely affect many 3D film or digital presentations. In general, projection systems that have non-identical illumination and/or projection geometries for the respective left- and right-eye images are susceptible to this (e.g., digital projection systems using time-domain multiplexing of the imagers to project left- and right-eye images from the same physical imagers with identical geometries do not suffer from differential illumination issues).

While brightness disparity compensation can benefit both film-based and digital presentations, for film-based systems, it is further desirable to improve the 3D presentation quality by improving the image separation, color, and brightness so as to compete with digital cinema presentations.

### SUMMARY OF THE INVENTION

Embodiments of the present principles provide, among others, a method and system for reducing brightness disparity in stereoscopic image pairs for three-dimensional (3D) projection.

One embodiment provides a method for use in three-dimensional (3D) projection, which includes: (a) obtaining a brightness adjustment for reducing brightness disparity between two images in a stereoscopic image pair, and (b) applying the brightness adjustment to at least one region of at least one of the two images.

Another embodiment provides a plurality of images for projection in a three-dimensional (3D) projection system, including a first set of images and a second set of images, each image from the first set of images forming a stereoscopic image pair with an associated image from the second set of images; in which at least one of the first set and the second set of images incorporates a brightness adjustment for at least partially compensating for brightness disparity between respective images of any stereoscopic image pair, and the brightness disparity is associated with the projection system.

Another embodiment provides a system for three-dimensional (3D) projection, which includes a projector, and at least one processor configured for establishing a brightness adjustment based on brightness disparity information associated with the projector, and applying the brightness adjustment to at least one region of one or more images for 3D projection.

Another embodiment provides a computer readable medium having stored instructions, which, when executed by a processor, will perform a method that includes: (a) obtaining a brightness adjustment for reducing brightness disparity between two images in a stereoscopic image pair, and (b) applying the brightness adjustment to at least one region of at least one of the two images.

### BRIEF DESCRIPTION OF THE DRAWINGS

The teachings of the present invention can be readily understood by considering the following detailed description in conjunction with the accompanying drawings, in which:

FIG. 1 illustrates a dual lens stereoscopic film projection system;

FIG. 2 illustrates projected left- and right-eye images from the stereoscopic film projection system of FIG. 1;

FIG. 3 illustrates a contour of illumination from the system of FIG. 1;

FIG. 4 illustrates brightness profiles of right- and left-eye images projected on a screen;

FIG. 5 is a portion of an over-and-under stereoscopic film of the prior art;

FIG. 6 is a portion of an over-and-under stereoscopic film of the present invention with increased density for correcting brightness disparity between stereoscopic images;

FIG. 7 illustrates one embodiment for producing a brightness-corrected film of FIG. 6;

FIG. 8 illustrates another embodiment for producing a film or digital file with brightness correction;

FIG. 9 illustrates a dual lens digital projection system; and

FIG. 10 illustrates another embodiment for reducing brightness disparity between two projected stereoscopic images.

To facilitate understanding, identical reference numerals have been used, where possible, to designate identical elements that are common to the figures. The drawings are not to scale, and one or more features may be expanded or reduced for clarity.

### DETAILED DESCRIPTION

Prior single-projector 3D film systems use a dual lens to simultaneously project left- and right-eye images laid out above and below each other on the same strip of film. These prior art “over-and-under” 3D projection systems exhibit differential illuminations between the left- and right-eye images, especially apparent at the top and bottom of the screen. This is distracting to audiences, causes eyestrain, and detracts from the 3D presentation. The differential illumination is primarily caused by the left- and right-eye film images receiving different illumination profiles due to their opposite positions in the film gate.

The present invention characterizes these differences and compensates accordingly by providing a print film or digital file corresponding to the print film, having brightness adjustments in one or more regions where one of the images of a stereoscopic pair would otherwise be too bright compared to its stereoscopic counterpart.

Existing projection systems include a single, standard, 2D film projector having a dual lens configuration to project each of two images at the same time (one for the left eye, one for the right eye) and a filter inline with each of the left- and right-eye halves (typically the bottom and top, respectively) of the dual lens encodes the corresponding left- and right-eye images of a stereoscopic pair so that when projected on a screen, an audience wearing glasses with filters corresponding to those of the dual lens system and properly oriented, will perceive the left-eye image in their left eyes, and the right-eye image in their right eyes. This is discussed below as background to facilitate the description of the present invention.

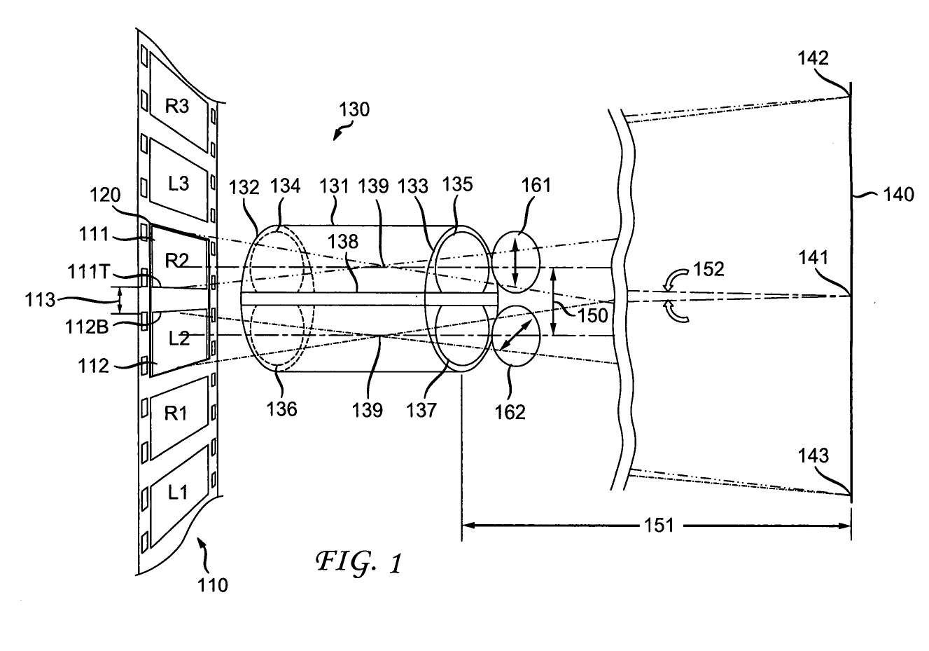

Referring to FIG. 1, an over/under lens 3D film projection system 100 is shown, also called a dual-lens 3D film projection system. Rectangular left-eye image 112 and rectangular right-eye image 111 (separated by an intra-frame gap 113), both on over/under 3D film 110, are simultaneously illuminated by a light source and condenser optics behind the film (not shown) while framed by aperture plate 120 (of which only the inner edge of the aperture is illustrated, for clarity) such that all other images on film 110 are not visible as they are covered by the portion of the aperture plate which is opaque.

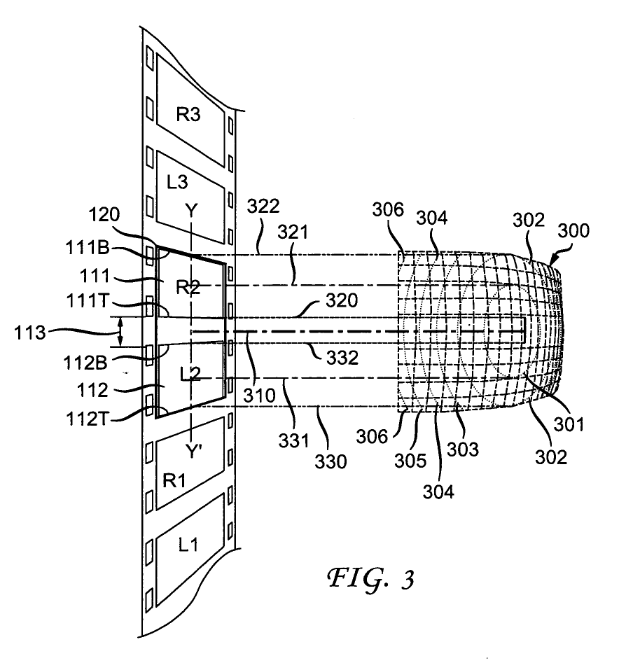

The illumination profile provided by the light source and condenser optics is discussed in greater detail with respect to FIG. 3.

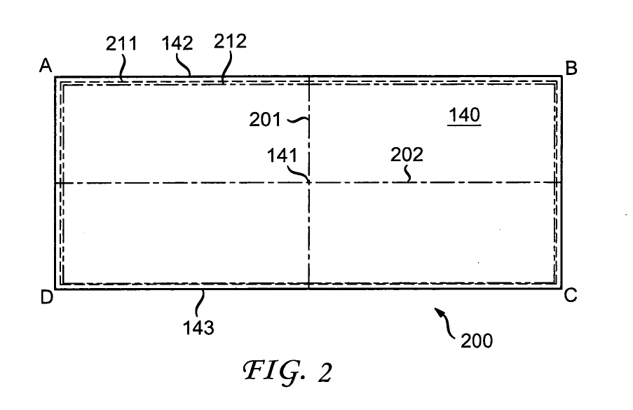

The images visible through aperture plate 120 are projected by over/under lens system 130 onto screen 140, generally aligned and superimposed as shown and discussed in conjunction with FIG. 2. In particular, the throw distance 151 from lens 130 to screen 140 and dual lens inter-axial distance 150 requires a convergence angle 152 to ensure that the projections of right- and left-eye images 111 and 112 are properly aligned on screen 140.

Over/under lens system 130 (also called a dual-lens system) includes body 131, entrance end 132, and exit end 133. The upper and lower halves of lens system 130 are separated by septum 138, which prevents stray light from crossing between halves. The upper half, typically associated with right-eye images (such as 111) has entrance lens 134 and exit lens 135. The lower half, typically associated with left-eye images (such as 112) has entrance lens 136 and exit lens 137. Other lens elements and aperture stops internal to each half of dual lens system 130 are not shown, again for clarity. Additional lens elements (also not shown), e.g., a magnifier following the exit end of dual lens 130, may also be added when appropriate to the proper adjustment of the projection system 100.

Projection screen 140 has viewing area center point 141 at which the projected images of the two film images 111 and 112 should be centered. Ideally, the top of both projected images is aligned at the top of the screen viewing area 142, and the bottom of the projected images is aligned at the bottom of the screen viewing area 143.

Shown in FIG. 1 are right-eye and left-eye specific filters or shutters 161 and 163, typically mounted on or near dual lens 130, e.g., after exit lenses 135 and 137, respectively, to encode the projected right- and left-eye images so that corresponding filters or shutters on an appropriate pair of glasses worn by each member of the audience ensure that the left-eye images are only viewed by the audience's left eyes and the right-eye images are only viewed by the audience's right eyes (as least as long as they are wearing the glasses). Various such filters for this purpose, including linear polarizers, anaglyphic (red and blue), interlaced interference comb filters, are all well-known. Active shutter glasses, for example using LCD shutters to alternate between blocking the left or right eye in synchrony with a like-timed shutter operating to extinguish the projection of the corresponding film image are also feasible. An apparatus incorporating circular polarizers for use in projecting stereoscopic images for 3D presentation is described in a commonly-owned PCT patent application (PCT/US09/006557), by Huber et al., “Improved Over-Under Lens for Three-Dimensional Projection” filed on Dec. 15, 2009.

In one example, filter 161 is an absorbing linear polarizer having vertical orientation, and filter 162 is an absorbing linear polarizer having horizontal orientation. Screen 140 would be a polarization preserving projection screen, e.g., a silver screen. Thus, the right-eye image 111 projected through the top half of dual lens 130 has vertical polarization and the left-eye image 112 projected through the bottom half of dual lens 130 has horizontal polarization, both of which are preserved as the projected images are reflected by screen 140. Audience members wearing glasses (not shown) with a right-eye linear polarizer having vertical axis of polarization and a left-eye linear polarizer having a horizontal axis of polarization will see the projected right-eye image 111 in their right eyes, and the projected left-eye image 112 in their left eyes.

FIG. 2 shows a projected presentation 200 of a stereoscopic image pair on the viewing portion of projection screen 140 with center point 141. Projected presentation 200 has vertical centerline 201, horizontal centerline 202 that intersect each other substantially at the screen's center point 141.

When properly aligned, the left- and right-eye projected images are horizontally centered on vertical centerline 201 and vertically centered on horizontal centerline 202, with perimeter defined by ABCD. The tops of the projected left- and right-eye images are close to the top 142 of the visible screen area, and the bottoms of the projected images are close to the bottom 143 of the visible screen area. In this situation, the boundaries of the resulting projected left- and right-eye image images 112 and 111 are represented by left-eye projected image boundary 212 (shown as dotted line) and right-eye projected image boundary 211 (shown as dashed line), respectively.

By virtue of the configuration of lens 130, images 111 and 112 on the film 110 become inverted after projection. Thus, the film 110 is provided in the projector with the images inverted such that the projected images would appear upright. As shown in FIG. 1, the top 111T of right-eye image 111 and the bottom 112B of left-eye image 112 and are located close to the center of the opening in aperture plate 120, while the bottom 111 B of right-eye image 111 and the top 112T of left-eye image 112 are located near the edge of the aperture plate opening. When projected, the tops 111T and 112T of the respective images will appear near the top edge 142 of the screen 140, and the bottoms 111B and 112B of the images will appear near the bottom edge 143 of the screen 140.

As previously mentioned, the illumination from the light source and condenser optics (not shown) is generally not uniform across the opening in aperture plate 120. Typically, the center of the opening in aperture plate 120 is the brightest, and the illumination falls off in a more or less radial pattern, as shown by example in FIG. 3, which illustrates an illumination profile 300 (or illuminant flux) across the opening in aperture plate 120. The maximum illumination 310 corresponds to the center of the opening in aperture plate 120, which also lies on the vertical centerline YY′ of images 111 and 112 and in the middle of intra-frame gap 113. Thus, typically, in a stereoscopic over-and under projection configuration as shown, the illuminator's brightest region, the very center, is not used to project any portion of an image onto screen.

The radially symmetric brightness distribution profile of this well-aligned example system is illustrated by contour lines 301-306, which represent lines of constant brightness. For some light sources, these contour lines 301-306 would form ellipses or other smooth shapes, rather than circles as shown in FIG. 3.

In one example, contour line 301 identifies brightness values that are 95% of the maximum brightness value 310 at the center of the aperture opening. Brightness values 320 and 332 along the centerline YY′ and corresponding to the top of right-eye image 111 and bottom of left-eye image 112, respectively, are both close to the maximum brightness 310, and in this example, are approximately equal to each other. In addition, contour lines 302, 303, 304, 305 and 306 represent respective brightness values of 90%, 85%, 80%, 75%, and 70% of maximum brightness 310.

From brightness profile 300, one can determine that the brightness value 330 at the top 112T of left-eye image 112 is approximately 90% that of central brightness value 310 (from its proximity to contour line 302), and approximately equal to brightness value 322 at the bottom 111B of right-eye image 111.

As a further illustration, brightness value 331 corresponds to a location along a side edge of left-eye image 112 and would be about 70% of central brightness value 310, as read from its proximity to contour line 306. Likewise, brightness value 321 corresponding to a location along the side edge of right-eye image 111 is also about 70% of central brightness value 310.

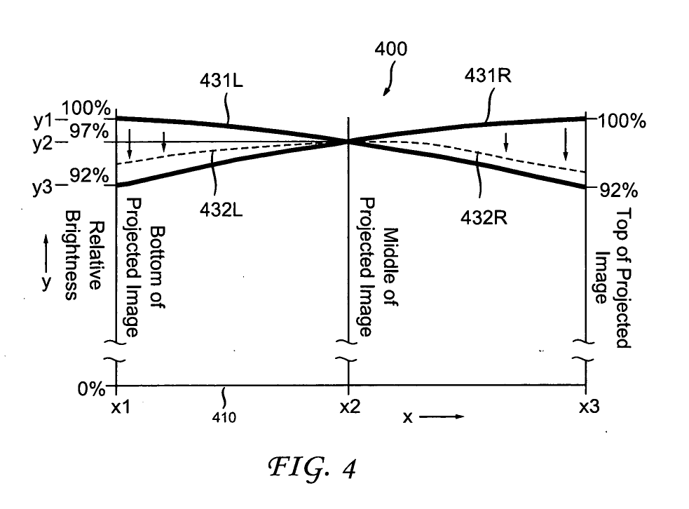

When the projection light source having illumination profile 300 is used for projecting stereoscopic images through the dual-lens system 130, it results in a brightness distribution at the screen, which can be represented by brightness profiles such as those shown in FIG. 4. Graph 400 shows the relative brightness profiles 431R and 431L, which plot, on the y-axis, relative brightness for the projected right- and left-eye images respectively, along the vertical centerline 201 on the screen (see FIG. 2) as a function of the height above the bottom edge 143 (along the x-axis).

Note that the relative brightness profiles can be obtained by measuring different brightness-related parameters, e.g., luminance or illuminance (luminance is a measure of how much luminous power is perceived by a person looking at a surface from a particular angle of view, whereas illuminance is a measure of the intensity of the incident light, and both are wavelength-weighted by the luminosity function to correlate with human brightness perception). Although each is measured in different units, i.e., luminance in lumens/steradian/m², and illuminance in lumens/m², they both include units of lumens, which provides the weighting to human vision. The measurement procedure can vary according to which parameter is being measured. Although other brightness-related parameters, e.g., radiance or irradiance, can also be used for obtaining brightness profiles, it is more convenient to measure luminance or illuminance because light meters for measuring these parameters are commonly available.

Since the present invention is directed towards correcting for the brightness disparity for a stereoscopic image pair arising from the difference in illumination profiles for projecting the right- and left-eye images, brightness variations associated with image content represented on the film 110 and stereoscopic disparities between images 111 and 112 are excluded from the brightness profiles in FIG. 4. In other words, the brightness disparity of interest is only a function of the system configurations such as geometry of the illuminator, aperture plate opening, projection optical components (e.g., lenses, filters), and the screen.

Thus, although references are made in this discussion to the relative brightness of projected images of a stereoscopic pair used for brightness measurements, it is understood that this assumes substantially equal and uniform density for the right- and left-eye images (although, in practice, this is not required for the actual images in a film), and alternatively, it may refer to a configuration of operating the projector “open gate”, i.e., with no film in the projector. In other words, the relative brightness profiles in FIG. 4 can also represent profiles of the projection light through the respective upper and lower lenses of FIG. 1 with or without film 110 in place.

In FIG. 4, the x-axis starts from a minimum height coordinate x1 corresponding to the bottom edge 143 of the visible portion of projection screen 140, increases to an intermediate height coordinate x2 corresponding to the horizontal centerline 202, and to a maximum height coordinate x3 corresponding to the top edge 142 of the screen.

On the y-axis, the maximum relative brightness value y1 of 100% corresponds to the brightest portion of the projected images. In this example, the brightness profiles 431L and 431R show that the brightest portions correspond respectively to the bottom 1128 of projected left-eye image 112 (brightness level 332 in FIG. 3), and the top 111T of projected right-eye image 111 (brightness level 320 in FIG. 3).

In this example, brightness curves 431L and 431R are symmetrical with respect to each other about the height x2. In an alternative embodiment, the curves may be asymmetrical due to the pattern of illumination through the opening of aperture plate 120, the geometry of projection system 100, the nature of screen 140, or the seating positions of the audience (the last two factors being relevant only for brightness profiles derived from luminance measurements). For the purpose of clarity, however, this discussion relates to a system having symmetric falloff of the illumination with respect to the horizontal center line of the screen, i.e., height x2 in graph 400.

Along the vertical centerline 201, the minimum brightness is about 92% at coordinate y3 for the bottom of projected right-eye image (height coordinate x1) and the top of projected left-eye image (height coordinate x3). The projected right- and left-eye images have equal brightness (about 97%) only around coordinate x2, i.e., near the horizontal centerline 202.

As evident in FIG.4, for any height coordinate x smaller than x2 (i.e., below the horizontal centerline 202), the projected left-eye image is brighter than the projected right-eye image, while for any x larger than x2 (i.e., above the horizontal centerline 202), the projected right-eye image is brighter than the projected left-eye image.

The brightness disparity between the two stereoscopic images, as shown by the divergence of brightness curves 431L and 431R, can be reduced or eliminated by adding extra density to the film print 110 in regions of respective images where the brightness curve of one image exceeds that of the other image. The amount of density to be added in a region is related to the ratio of the heights of the curves, that is, the differential brightness in the region. Density is the logarithm of the reciprocal of transmissivity. In a region where the brightness ratio of the brighter image to the dimmer image is ‘r’, the additional density may be calculated as log₁₀(r). Thus, in a region where the ratio of the brightnesses is 2:1 (i.e., 2.0), the additional density to be added to the brighter image would be log₁₀(2.0)=0.3. Alternatively, if represented in “stops”, log₂ would be used in the density calculation, in which case, the added density would be log₂(2)=1.0 stops.

For example, as shown in graph 400, at the bottom of the screen 143 (i.e., height coordinate x1) near the vertical centerline 201, the projected left-eye image has a relative brightness of 100%, which is higher than the brightness 92% of projected right-eye image in that same region. Thus, to reduce the brightness disparity between the two projected images, the bottom 112B (see FIG. 3) of left-eye image 112 near the vertical centerline YY′ should be printed with an extra density of log₁₀(100/92)=0.036, or log₂(100/92)=0.12 stops, which would bring that portion of the brightness curve 431L downwards (shown by the down arrows), resulting in reduced brightness in the portion 432L of the brightness profile. Similarly, extra density may also be added to the top region 111T (see FIG. 3) of right-eye image 111 to reduce its brightness relative to that of the left-eye image 112 in that region, resulting in reduced brightness in the portion 432R of the brightness profile. Although not shown, extra density may be added so that the reduced brightness portion 432L or 432R coincides with the respective lower portion of curve 431R or 431L, i.e., the left- and right-projections have equal brightness.

Near the center of the images (height coordinate x2), in this example, no extra density is needed, since the relative brightness are substantially equal.

Alternatively, if it is desired that one or more portions of the projected left- and right-eye images should have a predetermined or given difference in brightness level (e.g., different from what is shown in curves 431L and 432R, and not necessarily equal in brightness for both images), an appropriate extra density can be computed and added to the suitable portion(s) of the corresponding image.

In still another embodiment, near the center of the images, a small amount of additional density may be added to one or both images so that there is no “cusp” at the point of intersection between the left- and right-eye brightness profiles 431L and 431R (at and around height coordinate x2). This has the advantage of avoiding a perception of a horizontal artifact at the middle of the screen where the rate of change of brightness is discontinuous (e.g., if there is a cusp in the slope of profiles 431L and 431R after correction) in the vertical direction for either the projected left- or right-eye image.

Alternatively, instead of adding density to a first stereoscopic image (e.g., right-eye image) to reduce its brightness relative to the second image (e.g., left-eye image), it is also possible to reduce density (to increase brightness) of the second image relative to the first image. Thus, density adjustment can be used to refer to either density increase or decrease, as appropriate for the specific image involved.

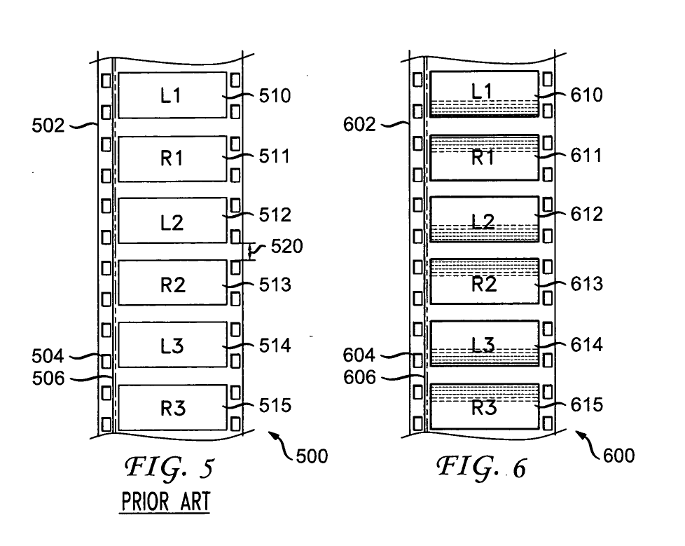

FIG. 5 shows a strip of stereographic motion picture film 500 of the prior art. Film 502 has perforations 504 and can bear an optical soundtrack 506, which may be digital. Left-eye images 510, 512 and 514 form stereoscopic pairs with right-eye images 511, 513 and 515, respectively. Intra-frame gap 520 is the space between the frames of a stereoscopic pair, such as left-eye image 512 and right-eye image 513. Images 510-515 generally bear pictures (not shown) encoded spatially as modulations of density in the emulsions of print film 500.

FIG. 6 shows a strip of stereographic motion picture film 600 with densities added in certain portions for compensating for differential brightness, according to one embodiment of the present principles. Film 602, with perforations 604 and optical soundtrack 606 contains images 610-615 corresponding to original or uncompensated images 510-515 and having corresponding stereoscopic relationships (e.g., left-eye image 612 forms a stereoscopic pair with right-eye image 613). However, each left-eye image 610, 612 and 614 has been printed with extra density in the bottom portion of each image, since in the exemplary system discussed above (see FIG. 4), the bottom portion of the left-eye image, if not compensated for brightness disparity, would be brighter than the bottom portion of the corresponding right-eye image. For left-eye images 610, 612 and 614, the extra density increases progressively from the center towards the bottom edge of left-eye images, which is consistent with the difference between the relative brightness values of profiles 431L and 432L from height coordinate x2 to x1, illustrating that the extra density has at least partially compensated for the differential brightness between the left- and right-eye profiles 431L and 431R.

Similarly, the right-eye images 611, 613 and 615 have been printed with extra density in the top portion of each image (progressively increasing density towards the top of these images), so as to reduce the brightness disparity between the right- and left-eye images towards the top portion of the projected images.

At any location of a first-eye image where extra density is needed (to reduce the brightness of the first-eye image compared to the second-eye image), the amount of extra density to be added to that location for all the first-eye images (which may be referred to as a first set of images) in print film 600 is given by the logarithm of the ratio of the brightness of the first-eye image to the brightness of the corresponding region in the second-eye image. In other words, if I₁>I₂, where I_{1,} I₂ represent respective brightness-related parameters (e.g., luminance or illuminance) measured or estimated for the first- and second-eye images at certain corresponding locations, the density to be added to the first-eye image at that location is given by Log [(I₁)/I₂]. However, if I₁ is less than or equal to I₂, no extra density will be added to the first-eye image (though there may be extra density added to the corresponding location of the second-eye image, e.g., if I₁<I₂).

Returning to the example of FIG. 6, the bottom portion of left-eye image 610 can be divided into various regions, e.g., based on the height above the bottom edge of the image. These regions, when projected onto the screen, will correspond to regions on the screen defined by the x coordinates (e.g., as horizontal regions defined by different ranges of x coordinates) in FIG. 4. In one example, it is assumed that the brightness graph 400 of FIG. 4 apply across the entire width of the screen, i.e., not only at the center vertical line 201. Thus, a constant extra density (determined in part by the procedures described in connection with FIG. 4) can be added to all locations within the same horizontal regions of all images for the same eye.

In a more general case, other parts of the projected image space (e.g., near the left vertical edge AB or right vertical edge of the screen) may not have the same brightness distribution as graph 400, in which case, additional brightness measurements will be needed at other locations in order to determine appropriate extra densities to be applied to other parts of the left- and right-eye images. Thus, differential brightness measurements (e.g., brightness measurements performed for a stereoscopic image pair) can be made at a plurality of locations across projection screen 140, to generate brightness graphs at different locations across the width of screen 140 (e.g., brightness profiles along different vertical lines between left vertical edge AD and right vertical edge BC in FIG. 2). Such measurements can then be interpolated or extrapolated to estimate the different brightness values between projected right-eye image 211 and left-eye image 212 for any location on projection screen 140. In another embodiment, the measurements can be used to determine parameters to an equation modeling the different brightnesses between the projected images 211 and 212.

Those skilled in the art will recognize that for most projection screens, the luminance (which indicates how much luminous power will be perceived by a person looking at the surface from a particular angle of view, i.e., how bright the surface will appear to the person) as measured after reflection from the screen will be affected by the projection angle, viewing angle, and the dispersion of the projection screen surface (e.g., a Lambertian surface or the dispersion equation for a screen with gain). While these additional factors can make the apparent brightness across a projection screen seem very complex, the correction produced by the present invention is not affected by these factors, at least not in the first order. The reason is that the correction is applied on the basis of brightness differences between the projected left- and right-eye images, with the additional factors affecting both images in substantially equal manner.

In a properly aligned system, the slight difference in vertical position of exit lens 135 with respect to exit lens 137, is small compared to the distance from output end 133 to screen 140. As such, the effect of different projections angles is, to the first order, negligibly small. Likewise, for a differential brightness measurement, the viewing angle can be considered the same for left- and right-eye brightness readings (neglecting that the viewing angle should be shifted to account for the inter-ocular separation of the average audience member). So, except in unusually (even impractically) extreme circumstances, the diffusion function for a particular screen for a brightness reading of the left- and right-eyes will be substantially the same for both the left- and right-eye brightness readings at a point on the screen. Thus, the ratio of the left- and right-eye brightness readings will represent the differential brightness at the point where the readings are taken, and the logarithm of that ratio will determine the density to be added, and will be, for most practical uses of the present invention, negligibly influenced by the other factors (e.g., projection and viewing angles, dispersion of the screen).

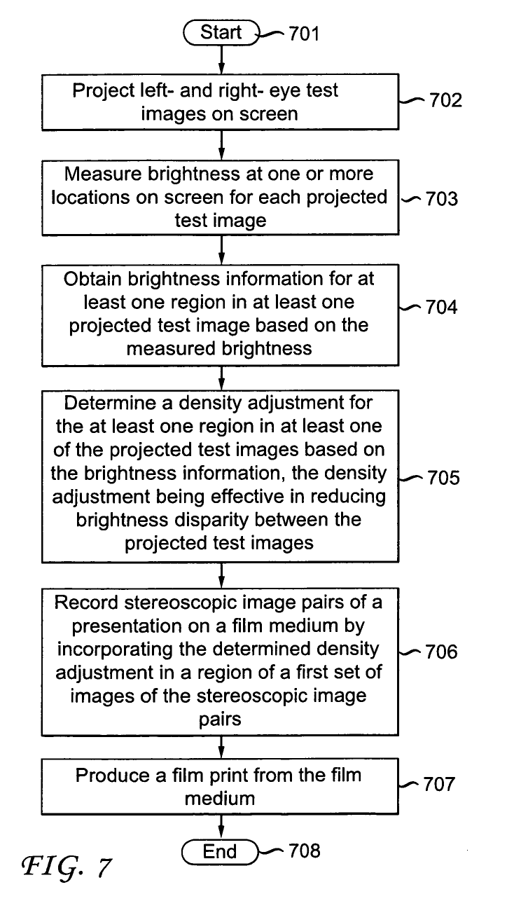

FIG. 7 illustrates a process 700 for correcting brightness disparity between two stereoscopic images in an over-and-under stereoscopic film presentation, according to one embodiment of the present principles.

In step 701, a representative projection system for projecting stereoscopic images is identified, e.g., system 100, with components such as illuminator, aperture plate, dual lens, left- and right-eye projection lens filters (e.g., polarizers) and projection screen. For some embodiments of process 700, the left- and right-eye lens filters are not needed. Furthermore, the over-and-under format should be identified, e.g., the aspect ratio of images 111 and 112 and the size of intra-frame gap 113).

In step 702, a dual-lens projection system 100 is turned on, and allowed to stabilize (i.e., achieve an operating equilibrium), e.g., with left- and right-eye test images projected onto a screen. Although different patterns may be used for the test images, the left- and right-eye images should have substantially the same image densities at corresponding regions so that there will not be any brightness disparity arising from the image content of the test images (so that the brightness disparity to be measured will reflect differences arising only from the projection system and components). In one embodiment of this process, the dual-lens projector is operated without any film being present, i.e., no test images are projected (alternatively, the test images can be considered blank images). In this configuration, the steps in process 700 can be performed as described below, with the projected left- and right-eye test images representing “blank” illumination from the first and second projection lenses.

In step 703, the brightness at one or more test points or locations on the screen is measured separately for each image of a stereoscopic image pair, e.g., by performing a brightness measurement for a first image (i.e., for one eye) with the lens for the second image (for the other eye) covered up, or blocking the projection of the second image, and repeating the procedure for the second image. Different approaches may be used for performing the brightness measurements, e.g., by measuring either luminance or illuminance.

For illuminance measurements, a light meter is positioned at each (one or more) selected measurement point or test location at or near the screen so as to measure the incident light from the projector. In one embodiment, the illuminance from each lens 135 and 137 is measured at each test point on or near the screen. These separate measurements can be made by blocking light from one or the lenses for one stereoscopic image, or if lens filters (e.g., polarizers, etc.) are installed in the system of FIG. 1, by using an appropriate filter in front of the meter to filter out the light from the corresponding lens. However, it is generally easier to cover a different one of exit lenses 135 and 137 in each of two brightness measurements for the stereoscopic image pair.

In another embodiment of step 703, the luminance (instead of illuminance) at each test location on the screen is measured from a common vantage point, for example, from a position near the center of the audience seating area. Luminance is typically measured with a spot meter, whose field of view defines the size of the test or measurement location. Again, if projection filters for the respective right- and left-eye images are present, the luminance can be measured with a photometer viewing at a test location through appropriate viewing filters, or by blocking the light from a different one of exit lenses 135 and 137 in each of two brightness measurements. From a practical viewpoint, a luminance measurement is preferred over illuminance, because it is easier to position a light meter in an audience area to measure light intensity reflected from the screen, as opposed to mounting the light meter at different locations of the screen to measure incident light.

For luminance measurements, care must be taken when selecting the viewing filters for use with the photometer. For example, if circular polarizers are used in the dual-lens systems for encoding the stereoscopic images, the filter (e.g., polarizer) for filtering out a given projected image before the photometer will be different (opposite) for luminance versus illuminance measurements. Specifically, the selection of filters for measuring luminance should take into account that circularly polarized projection light will, upon reflecting off the screen, change its sense of circular polarization direction.

If the differential brightness is expected to be distributed according to a known pattern, especially a symmetrical one, it is possible that a model of the differential brightness can be fitted to a single differential brightness reading (i.e., two readings, one from each of the projected left- and right-eye images at a predetermined point). However, in general, a measurement of the differential brightness will be needed at each of a plurality of points or locations on the screen, e.g., at least two differential brightness measurements, one each for at least two different locations.

In an alternative embodiment, system 100 can be operated with a strip of test film with markings to aid in the measurements, e.g., by periodically displaying crosshairs at the desired measurement points, but removing those crosshairs for intervals of time sufficient for taking the brightness measurements.

In step 704, brightness measurements (e.g., of a brightness-related parameter) from the test points are used to estimate or calculate brightness information such as differential brightness, for at least one region in each of the projected left- and right-eye images. Note that such a differential brightness estimation does not necessarily have to be performed for the entire extent of the projected images. In one embodiment, this estimation can be done by an interpolation and/or extrapolation of the measured values. In another embodiment, a mathematical model of differential brightness is fitted to the measurement data, and then used to estimate the differential brightness in at least one region of the projected image, or throughout the extent of the projected image.

In step 705, density adjustment, e.g., an increase, for at least one region in at least one of the left- and right-eye images is determined from the brightness information of step 704. The density increase is effective in reducing brightness disparity or differential brightness in the projected left- and right-eye images. This density increase may be given by the logarithm of the ratio of the brightness of a first eye image in a region to the brightness of the second (or opposite) eye image in the corresponding region. Thus, if one region of the first eye image is brighter than the corresponding region of the second eye image, the density to be added to the first eye image is given by Log [(I₁)/I₂], where I₁, >I₂ₗ and I₁, I₂ are respective brightness-related parameters (e.g., luminance or illuminance) that are measured or estimated for the first and second eye images in those regions. No added density is needed for the region of the first eye image if its brightness is equal to or less than that of the corresponding region in the second eye image.

Alternatively, steps 704 and 705 can be combined into a single step in which the increased density determination is made directly from the brightness measurements, e.g., by using a lookup table.

In step 706, left- and right-eye images, i.e., stereoscopic image pairs, of a 3-dimensional presentation or show are recorded on a film medium by incorporating the density adjustment from step 705 (or, for a film negative, the opposite density adjustment is used) in a region of at least one set of the stereoscopic images, i.e., a set of all left-eye images or all right-eye images of the show. This region of the presentation's images for which the density adjustment is incorporated should correspond to the same region of the test image for which brightness information is obtained in step 704.

This recorded negative film has image densities that, when printed in step 707, are effective for compensating for or reducing brightness disparity or differential brightness in the projected left- and right-eye images (i.e., brightness disparity associated with the projection system). For each stereoscopic image pair, the film negative is underexposed (i.e., a density decrease after developing) in regions of at least one image corresponding to those regions of a film print (to be made from this negative) where extra density, i.e., density increase determined in step 705, is called for, with the underexposed amount being selected to produce the appropriate extra density in the corresponding film print.

Alternatively, instead of or in addition to recording on a film negative, the density adjustments can be recorded in digital format for use later on. For example, the numeric codes representing the density values that would otherwise be used to record a corrected film negative (or positive) can be stored in a file and printed at a later time.

In film printing step 707, a print is made with regions of extra density corresponding to the underexposed regions of the film negative that has been properly developed.

Alternatively, a film positive can be made in step 706, with regions of extra density being recorded directly (e.g., by overexposure in the corresponding regions of the respective stereoscopic images), and printing step 707 (if needed) would make inter-positive copies of the film positive. Processing of the film negative or positive and film prints are done using techniques known in the field.

In still another embodiment, the regions corresponding to increased density in the film print can be written as underexposed regions in a film negative in otherwise flatly-exposed frames (i.e., frames that are effectively grey (preferably, light grey) when developed, except for the underexposed, or clearer, regions). The negative film so produced contains only the inverse of the extra density correction and can provide an apodization function that, when bi-packed with a prior art film negative, i.e., a film negative without any density adjustments for differential brightness compensation, and printed in a special printing pass to make a film print having the compensated densities. In this embodiment, the correction negative can be made once and used to provide brightness correction for prints of all films to be used with projection systems similar to system 100.

Process 700 concludes at step 708. The developed, printed film can be displayed in a theatre of which the projection system 100 is sufficiently representative.

In another embodiment, due to the densities already present in the image content itself, the density to be added to a region (called for in step 705) may result in saturation of a print film, or a “blowing out” of the negative, where the necessary exposures move into the non-linear regions of the film's sensiometric curves. In such cases, the procedure in step 705 can be modified, for example, by reducing the density of the dimmer image region, and/or in combination with adding a density amount to the brighter image region that is less than the original density called for. By modifying the density of both images in the stereoscopic pair, the brightness disparity can be reduced or eliminated (as when the increased density of the brighter image plus the magnitude of the reduced density of the dimmer image equals the added density originally called for in the brighter image), while avoiding or reducing potential clipping at the brightest or darkest exposures. In such an embodiment, care should be taken to avoid discontinuities in the slope of the brightness, other than as provided for in the image content itself. Further, within a scene, temporal changes in the shape of the brightness compensation should be avoided or minimized.

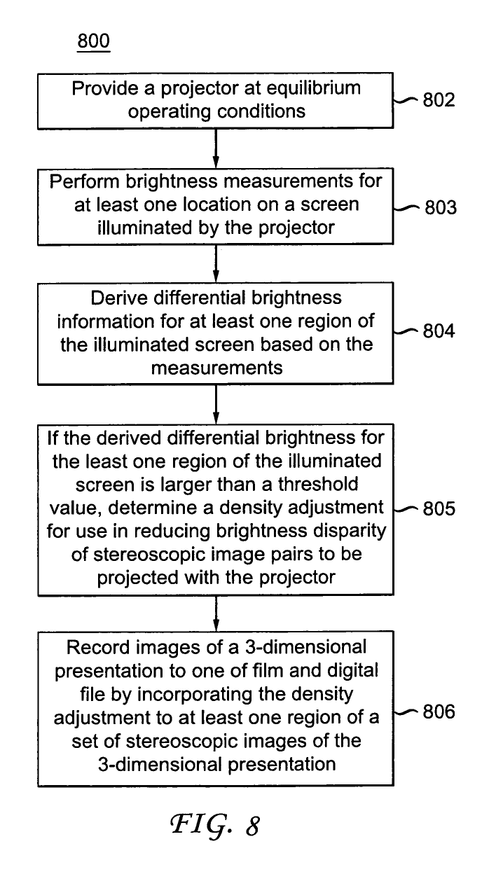

FIG. 8 illustrates another method 800 suitable for producing a film or digital image file to reduce brightness disparity between projected left- and right-eye images of stereoscopic image pairs. In step 802, a projector such as a dual-lens system for projecting left- and right-eye images with two different lens assemblies is allowed to achieve operating equilibrium conditions. Although this stabilization step is optional, it helps provide repeatable data if brightness measurements are to be performed. Thus, the stabilization step is more useful for film-based systems, where the arc lamp illumination is bulb-temperature dependent and arc position sensitive. If method 800 is adapted for use with certain video or digital projection systems, stabilization is less critical because the light sources, e.g., a filament, a cathode ray tube (CRT), a light emitting diode (LED), and so on, may have a much shorter stabilization time.

In step 803, brightness measurements are made for at least one point or location on a screen illuminated by the projector to obtain differential brightness information OF data associated with projection of stereoscopic image pairs. Such measurements can be done on projected stereoscopic test images, or in “open gate” configuration, i.e., blank illumination from the projection lens assemblies used for projecting the left- and right-eye images.

More specifically, brightness measurements are performed for at least one location on the screen (i.e., projected image space). If stereoscopic test images are used, they can be provided in a film or digital file, and projected for use in characterizing differential brightness (or brightness disparity) of the images. In the case of the digital file, images are usually stored in an encoded, compressed form (e.g., JPEG2000) requiring decoding for presentation by the projector (such encoded files and decoding by an image processor, not shown, is well known). The brightness measurements may be performed by measuring the luminance or illuminance of the two stereoscopic test images. Similar procedures as described for step 703 can be used.

If brightness measurements are performed in open gate, without any film or test images (i.e., similar to projecting clear images), luminance or illuminance can be measured at one or more locations of the screen with illumination through a first projection lens assembly (e.g., used for projection of right-eye images), and repeating the measurements for illumination through the second projection lens assembly (e.g., used to projection of left-eye images). In a digital projector system, the projector typically has a ‘white field’ mode (e.g., an internal test pattern) that can be selected from a menu. In this situation, no image data is used, and each element of the imager is turned and held ‘on’ to provide maximum light throughout at all pixels.

In other words, the brightness measurements performed on a stereoscopic image pair (for obtaining differential brightness information) correspond to measuring the illumination profile or characteristics of the respective lens assemblies of the projection system (including the illuminating source, lens assembly with associated components and filters, display screen, and the configuration and alignment of these components) that are used for projecting the two stereoscopic images.

Note that there are situations in which actual measurements can be omitted, i.e., steps 802 and 803 are optional in some embodiments. For example, if there is prior knowledge regarding the differential brightness associated with regions of the projected stereoscopic images, then a differential brightness measurement for the stereoscopic images may not be necessary for determining an appropriate compensation, or at least a beneficial one (where an incomplete compensation is better than no compensation at all), for the differential brightness. Such prior knowledge may be obtained from experience, by estimates, or from computation based on certain parameters of the projection's illuminator (e.g., reflector geometry, plasma arc size, illuminator alignment, among others, or the projector's illumination profile 300 as shown in FIG. 3), combined with the geometry of images 111 and 112 and intra-frame gap 113. In the absence of such prior knowledge, however, brightness measurements on both stereoscopic images would generally be needed.

Although better accuracy can be obtained by performing measurements for both stereoscopic images, in some situations it may be sufficient and more efficient to perform brightness measurements for only one of the images and assume that symmetries (e.g., those exhibited by illumination profile 300) apply, thereby allowing a measurement made at a point or location on screen 140 for one image of a stereoscopic pair to be applied to the other image of the pair, but for positions on the screen opposite the horizontal centerline 202 or center point 141. Similarly, that same symmetry may be exploited to allow a measurement made for one image at a location on one side of the vertical centerline 201 to be assumed to also apply to the same image but at a location on the other side of vertical centerline 201, opposite the measurement location.

In step 804, brightness information, e.g., differential brightness, for at least one region of the projected left- and right-eye images of the stereoscopic test pair, or for at least one region of the screen illuminated by the first and second lens assemblies, is derived from the measurements at respective measurement locations from step 803. For simplicity, the region for which the differential brightness information is derived can also be referred to as a region of the projected image space (i.e., it may correspond to projected test images or the open gate illumination).

The differential brightness can be derived by interpolation and/or extrapolation, similar to that previously described for step 704. In one embodiment, the entire extent of each projected image may be divided into a number of regions, and brightness information for each region of the stereoscopic image pairs can be estimated or derived from the measurements obtained in step 803 closest in location to that region.

In step 805, a comparison is made between the differential brightness of the projected test images or illuminated screen and a predetermined threshold value. If the differential brightness exceeds the threshold value, then a determination is made for an amount of density adjustment, e.g., increase or decrease, that would be needed for reducing brightness disparity in the corresponding regions of stereoscopic image pairs (e.g., of a film or digital image file for 3D presentation) to be projected with the projector. Again, such determination may be done according to the procedures previously described.

If the differential brightness is below the threshold (and thus considered acceptable), no density correction would be needed in that region of stereoscopic images of a 3D film or digital file to be used with the projection system.

In step 806, images for a stereoscopic or 3D presentation are recorded to at least one of a film or a digital file. The recording is done by incorporating the density adjustment determined from step 805 to at least one region of a set of stereoscopic images, i.e., the density adjustment is applied to the same region of a set of all right-eye (or all left-eye) images of the presentation, where that region on the recorded images corresponds to the region of projected image space for which differential brightness is obtained. These “brightness-corrected” images may be recorded either on negative or positive films, as previously described in connection with FIG. 7. Alternatively, numeric codes representing the density values (i.e., with density adjusted) can be stored in a digital file for use in making a film print at a later time, or the density adjustments can be stored in digital format for use with digital projectors. In an optional step (not shown in FIG. 8), one or more film prints may be made from the film negative or positive.

Aside from a dual-lens single projector system, the present principles can also be applied to synchronized dual film projectors (not shown), where one projector projects the left-eye images and the other projector projects the right-eye images, each through an ordinary projection lens (i.e., not a dual lens such as dual lens 130). In a dual projector embodiment, the dual lens inter-axial distance 150 would be substantially greater, and factors affecting brightness that were previously negligible (e.g., projection angle of incidence), can become significant, since the projection lenses of each projector would be substantially farther apart than in dual lens 130.

As mentioned, the above method for brightness disparity correction can be applied to certain digital 3D projection systems that use separate lenses or optical components to project the right- and left-eye images of stereoscopic image pairs. Such systems may include single-projector or dual-projector systems, e.g., Christie 3D2P dual-projector system marketed by Christie Digital Systems USA, Inc., of Cypress, Calif., U.S.A., or Sony SRX-R220 4K single-projector system with a dual lens 3D adaptor such as the LKRL-A002, both marketed by Sony Electronics, Inc. of San Diego, Calif., U.S.A. In the single projector system, different physical portions of a common imager are projected onto the screen by separate projection lenses.

For example, a digital projector may incorporate an imager upon which a first region is used for the right-eye images and a second region is used for the left-eye images. In such an embodiment, the display of the stereoscopic pair will suffer the same problems of differential brightness described above for film because of the different illumination of the regions of the imager used for the respective stereoscopic images.

In such an embodiment, a similar compensation can be applied to the stereoscopic image pair. This compensation can be applied (e.g., by one or more processors or a server such as a digital cinema server) to the respective image data either as it is prepared for distribution to a player that will play out to the projector, or by the player itself in advance of play-out or in real-time (i.e., compensation being applied to one or more images from an uncompensated file or streamed media as other compensated images are being played out) by real-time computation as the images are transmitted to the projector, by real-time computation in the projector itself, or in real-time in the imaging electronics, or a combination thereof. The computation of compensation or correction in the server or with real-time processing can be performed using similar process as described above (e.g., including modifying one or more steps outlined in FIG. 7 and/or FIG. 8) for film-based systems to produce similar results for reducing brightness disparity in the digital stereoscopic images.

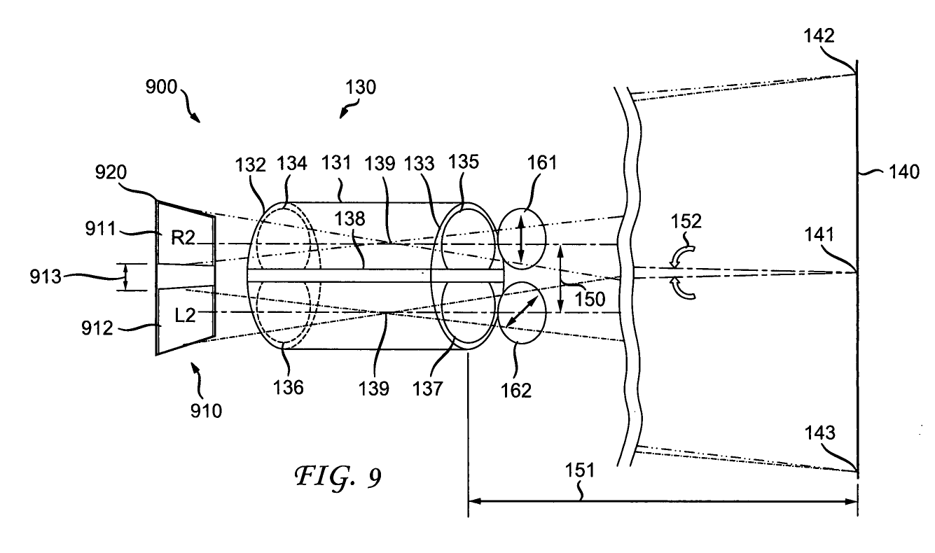

An example of a digital projector system 900 is shown schematically in FIG. 9, which includes a digital projector 910 and a dual-lens assembly 130 such as that used in the film projector of FIG. 1. In this case, the system 900 is a single imager system, and only the imager 920 is shown (e.g., color wheel and illuminator are omitted). Other systems can have three imagers (one each for the primary colors red, green and blue), and would have combiners that superimpose them optically, which can be considered as having a single three-color imager, or three separate monochrome imagers. In this context, the word “imager” can be used as a general reference to deformable mirror display (DMD), liquid crystal on silicon (LCOS), light emitting diode (LED) matrix display, scanned laser raster, and so on. In other words, it refers to a unit, component, assembly or sub-system on which the image is formed by electronics for projection. In most cases, the light source or illuminator is separate or different from the imager, but in some cases, the imager can be emissive (include the light source), e.g., LED matrix. Popular imager technologies include micro-mirror arrays, such as those produce by Texas Instruments of Dallas, Tex., and liquid crystal modulators, such as the liquid crystal on silicon (LCOS) imagers produced by Sony Electronics.

The imager 920 creates a dynamically alterable right-eye image 911 and a corresponding left-eye image 912. Similar to the configuration in FIG. 1, the right-eye image 911 is projected by the top portion of the lens assembly 130, and the left-eye image 912 is projected by the bottom portion of the lens assembly 130. A gap 913, which separates images 911 and 912, may be an unused portion of imager 920. The gap 913 may be considerably smaller than the corresponding gap (e.g., intra-frame gap 113 in FIG. 1) in a 3D film, since the imager 920 does not move or translate as a whole (unlike the physical advancement of a film print), but instead, remain stationary (except for tilting in different directions for mirrors in a DMD), images 911 and 912 may be more stable.

Also, since the lens or lens system 130 is less likely to be removed from the projector (e.g., as opposed to a film projector when film would be threaded or removed), there can be more precise alignment, including the use of a vane projecting from lens 130 toward imager 920 and coplanar with septum 138.

Note that only one imager 920 is shown here. Some color projectors have only a single imager with a color wheel or other dynamically switchable color filter (not shown) that spins in, front of the single imager to allow it to dynamically display more than one color. While a red segment of the color wheel is between the imager and the lens, the imager modulates white light to display the red component of the image content. As the wheel (or color filter) progresses to green, the green component of the image content is displayed by the imager, and so on for each of the RGB primaries (red, green, blue) in the image.

FIG. 9 illustrates an imager that operates in a transmissive mode, i.e., light from an illuminator (not shown) passes through the imager as it would through a film. However, other imagers operate in a reflective mode, i.e., light from the illuminator impinges on the front of the imager and is reflected off of the imager. In some cases (e.g., many micro-mirror arrays) this reflection is off-axis, that is, other than perpendicular to the plane of the imager, and in other cases (e.g., most liquid crystal based imagers), the axis of illumination and reflected light are substantially perpendicular to the plane of the imager.

In most non-transmissive embodiments, additional folding optics, relay lenses, beamsplitters, and so on (known to one skilled in the art, but not shown in FIG. 9, for clarity) are needed to allow imager 920 to receive illumination and for lens 130 to be able to project images 911 and 912 onto screen 140. Digital cinema projectors are more complex, and three imagers (not shown) are used, one for each of the RGB primaries. The folding optics and beamsplitters, etc. are more complex, but still well known.

To compensate for differential brightness between stereoscopic images in digital projection systems that have different projection optical paths for the stereoscopic images, the procedures described above in connection with method 800 and HG. 8 can be used. For example, in order to compensate for brightness disparity between two stereoscopic images in a digital file, the brightness of pixels can be adjusted in appropriate regions of one or both images.

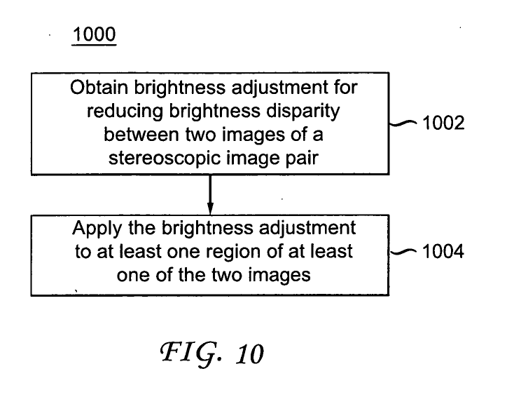

FIG. 10 illustrates an alternative method 1000 for correcting or reducing brightness disparity between two stereoscopic images for projection by a projection system. The method can be adapted for producing a film or digital image file containing stereoscopic images that have been compensated for brightness disparity arising from the projection system.

In step 1002, an amount of brightness adjustment is obtained for use in reducing brightness disparity between two images of a stereoscopic image pair (e.g., left-eye and right-eye images) to be projected by a projection system. The brightness adjustment can include at least one of: density increase for a film, or decreased pixel brightness for a digital image. In the context of pixel brightness correction, the amount of brightness adjustment is more appropriately expressed as a percentage of brightness change or modification, as opposed to being expressed in absolute terms.

In step 1004, the amount of brightness adjustment is applied to at least one region of at least one of the two images of the stereoscopic pair. When the brightness-corrected images are projected, the observed brightness disparity will be reduced compared to the uncorrected images.

When the projection system is a dual-lens system similar to that in FIG. 1 or FIG. 9, the brightness disparity observed between the two stereoscopic images is associated with the projection system because the disparity arises from differences in the illumination profiles used for projecting the respective images of the image pair.

The brightness adjustment in step 1002 can be derived from the brightness disparity or differential brightness associated with projecting the two images. As previously mentioned, there are circumstances under which differential brightness information can be obtained without actual measurements, e.g., by computation using different parameters associated with the projection systems, or by estimates based on experience or prior knowledge. The brightness disparity can also be measured by projecting stereoscopic test images and measuring one of illuminance and luminance using techniques previously discussed.

One or more features discussed above can be used for producing a stereoscopic film or digital image file that is compensated for brightness disparity by applying brightness adjustments to appropriate regions of at least a first set of images intended for viewing by one eye, e.g., a set of right- or left-eye images in the film or digital file.

For example, brightness disparity information associated with a stereoscopic projection system can be obtained for several locations on a screen, by at least one of measurement, estimation and computation. Brightness adjustments for use in reducing brightness disparity between projected stereoscopic image pairs can then be derived throughout the images based on the brightness disparity information from the several locations on the screen using one or more techniques previously described (including interpolation, extrapolation, and fitting of models).

The brightness adjustments can be applied to appropriate region(s) of at least a first set of images belonging to a stereoscopic film or digital image file, where each image in the first set of images forms a stereoscopic pair with a corresponding image from a second set of images in the film or digital file. A brightness-corrected film or digital image file can be produced by recording all images in accordance with the necessary brightness adjustments, e.g., increased density to a film or decreased pixel brightness in a digital file.

Since video projection systems (i.e., digital projection systems) commonly use brightness-based pixels for image projection, the adjustment necessary to reduce brightness of image regions having the greater illumination (compared to the other stereoscopic image) is done by decreasing the brightness for the corresponding pixels.

Note that if the brightness disparity information is measured using projected stereoscopic test images for a single frame, e.g., for the left- and right-eye images of a particular image pair, the amount of brightness adjustment derived from that single-frame measurement is applicable to all frames (i.e., no separate measurements are needed for separate frames).

Although various features of the present invention have been described in connection with specific examples, it is understood that these features can also be used in other variations, as illustrated in additional examples below.

In general, for any given location on the screen (i.e., projected image space) exhibiting brightness disparity that requires correction, several approaches can be used for making brightness adjustments or corrections.

For example, one can choose to adjust brightness by only darkening the images (or increasing density), e.g., referring to FIG. 4, by darkening the left-eye image towards the bottom portion of the projected image, thus bringing curve 431L down to 432L, and by darkening the right-eye image towards the top portion of the projected image, thus bringing curve 431R down to 432R. Alternatively, one can also choose to only lighten (increase brightness or decrease density) the images at appropriate portions of the respective images.

In one embodiment, brightness adjustments are done by only darkening one or both of the images of a stereoscopic pair at different regions or portions of the images. This approach has an advantage (namely to minimize encroachment upon the limits of the film or non-film projector's dynamic range) over another approach that provides adjustments to only one stereoscopic image, e.g., by brightening and darkening that stereoscopic image at different regions.

In another embodiment, brightness adjustments (both darkening and brightening) can be made to both images of a stereoscopic pair (e.g., at respective regions of the left- and right-eye images that project to a certain location on the screen). Thus, to reduce brightness disparity at one location on the screen, brightness may be decreased at one region or portion (corresponding to that screen location) of a first image that has a higher illumination, while at a corresponding region or portion of the other image, brightness may be increased. In other words, brightness disparity between stereoscopic images can be reduced by darkening and lightening respective left- and right-images at different portions that are appropriate for reducing the brightness disparity.

If both darkening and brightening are used, then it is possible to adjust brightness for only one of the two images of the stereoscopic pair by suitable adjustments at select portions or locations of that image (without also adjusting the brightness for the other eye's images), e.g., by increasing brightness in a region where the illumination for an image is too dim, or decreasing brightness if the illumination for that image is too dim. However, this approach has a side effect of stretching the dynamic range of that one eye's image on both the high and low ends, making certain regions darker and other regions brighter, as opposed to the first approach in Which both images of a stereoscopic pair are modified, where each is being made only darker, i.e., only stretching the dynamic range in one direction.

Furthermore, as discussed above in connection with FIG. 4, it can also be beneficial to (for a limited area in the near to where the two images are of equal illumination) darkening both the left and right eye images so that the second derivative of the illumination appears smooth, i.e., to avoid a “cusp” (discontinuities in the second derivative of illuminance can be perceived by humans as ‘edges’) Absent this correction, the image might otherwise appear ‘creased’ at the horizontal centerline 202.

Aside from providing a method for 3D projection, another embodiment of the invention provides a system having at least one processor and associated computer readable medium (e.g., hard drive, removable storage, read-only memory, random accessible memory, among others). In one embodiment, transient propagating signals are excluded from the computer readable medium. Program instructions are stored in the computer readable medium such that, when executed by one or more processors, will cause a method to be implemented according to one or more embodiments discussed above. In some embodiments, compensation for differential brightness can be implemented in real-time, e.g., with processing instructions embedded in a projector, using a conventional, uncompensated file and ordinary digital cinema server or streamed media. For example, brightness compensation of the present invention can be applied by one or more processors to the respective image data either as it is prepared for distribution to a player that will play out to the projector, by the player itself in advance of play-out or in real-time, by real-time computation as the images are transmitted to the projector, by real-time computation by the projector itself, or in real-time in the imaging electronics, or a combination thereof.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A method for use in three-dimensional (3D) projection, comprising:
(a) obtaining a brightness adjustment for reducing brightness disparity between two images in a stereoscopic image pair; and
(b) applying the brightness adjustment to at least one region of at least one of the two images.

2. The method of claim 1, wherein the brightness disparity arises from differences between two illumination profiles for use in projecting the two images.

3. The method of claim 1, wherein the brightness adjustment in step (a) is derived from brightness disparity information associated with projection of the two images.

4. The method of claim 3, wherein the brightness disparity information is obtained by at least one of: measurement, estimation and computation.

5. The method of claim 3, further comprising:
projecting the two images of the stereoscopic image pair on a screen; and
for at least one location on the screen, obtaining the brightness disparity information by measuring at least one of: illuminance and luminance.

6. The method of claim 3, wherein the brightness disparity information is obtained by computation based on parameters of a projection system.

7. The method of claim 1, wherein the stereoscopic image pair is provided in one of:
a film and a digital image file.

8. The method of claim 1, further comprising:
producing a film having at least a first set of stereoscopic images being subjected to the brightness adjustment of step (b).

9. The method of claim 1, further comprising:
creating a digital image file having at least a first set of stereoscopic images being subjected to brightness adjustment of step (b).

10. The method of claim 1, further comprises performing step (b) to one or more digital images in real-time as the one or more digital images are being played out.

11. A plurality of images for projection in a three-dimensional (3D) projection system, comprising:
a first set of images and a second set of images, each image from the first set of images forming a stereoscopic image pair with an associated image from the second set of images;
wherein at least one of the first set and the second set of images incorporates a brightness adjustment for at least partially compensating for brightness disparity between respective images of any stereoscopic image pair, said brightness disparity being associated with the projection system.

12. The images of claim 11, being provided as one of: a film and a digital file.

13. The images of claim 11, wherein the brightness adjustment is obtained based on one of: measurement, estimation and computation.

14. A system for three-dimensional (3D) projection, comprising:
a projector;
at least one processor configured for establishing a brightness adjustment based on brightness disparity information associated with the projector, and applying the brightness adjustment to at least one region of one or more images for 3D projection.

15. The system of claim 14, wherein the images are provided in one of: a film and a digital image file.

16. The system of claim 15, wherein the at least one processor is further configured for applying the brightness adjustment to at least one region of a first set of stereoscopic images in the film.

17. The system of claim 15, wherein the at least one processor is further configured for playing out the digital image file.

18. The system of claim 17, wherein the at least one processor is further configured for applying the brightness adjustment to at least one region of a first set of stereoscopic images prior to or in real-time as the digital image file is being played out.

19. The system of claim 14, wherein the brightness information is obtained based on at least one of: measurement, estimation and computation.

20. The system of claim 19, wherein the at least one processor is further configured for performing at least one measurement of brightness disparity associated with projection of stereoscopic images.

21. A computer readable medium having stored instructions, which, when executed by a processor, will perform a method comprising:
(a) obtaining a brightness adjustment for reducing brightness disparity between two images in a stereoscopic image pair; and
(b) applying the brightness adjustment to at least one region of at least one of the two images.
